(19) United States
(12) Patent Application Publication
(10) Pub. No.: US 2014/0204195 A1
(43) Pub. Date: Jul. 24, 2014

(54) MICROSCOPE, OBJECTIVE OPTICAL SYSTEM, AND IMAGE ACQUISITION APPARATUS

(71) Applicants: Yuji Katashiba, Kawasaki-shi (JP); Kazuhiko Kajiyama, Utsunomiya-shi (JP); Hirofumi Fujii, Toyono-gun (JP); Toshiaki Ikoma, Tokyo (JP)

(72) Inventors: Yuji Katashiba, Kawasaki-shi (JP); Kazuhiko Kajiyama, Utsunomiya-shi (JP); Hirofumi Fujii, Toyono-gun (JP); Toshiaki Ikoma, Tokyo (JP)

(73) Assignee: CANON KABUSHIKI KAISHA, Tokyo (JP)

(21) Appl. No.: 14/240,006

(22) PCT Filed: Jul. 30, 2012
(86) PCT No.: PCT/JP2012/004835

§ 371 Date: Feb. 20, 2014

(30) Foreign Application Priority Data
Aug. 22, 2011 (JP) 2011-180362

(51) Int. Cl. G02B 27/14; H04N 7/18

(52) U.S. Cl. CPC G02B 27/14; H04N 7/18
USPC 348/79; 359/629

(57) ABSTRACT

A microscope includes an objective optical system including an imaging optical system configured to form an image of an object, a re-imaging optical system configured to re-form an image of the object image formed by the imaging optical system, and a reflection unit arranged on an optical path between the imaging optical system and the re-imaging optical system and configured to be locally changeable in at least one of a position thereof in an optical axis direction and an inclination thereof relative to an optical axis, and an image sensor configured to capture the image re-formed by the objective optical system.

### TECHNICAL FIELD

The present invention relates to an objective optical system appropriately used for an image acquisition apparatus (e.g., a microscope) that acquires image data of a pathological sample, for example.

### BACKGROUND ART

In a recent pathological examination, an image acquisition system, which captures an image of a pathological sample using an image acquisition apparatus (e.g., a microscope) to acquire image data and displays the acquired image data on a display to allow a person to observe the displayed image data, has been paid attention to. The image acquisition system enables a plurality of persons to simultaneously observe the image data acquired by imaging the sample and share the image data with a pathologist at a distance.

If a large sample, which does not fall within a field of an objective lens, is observed in the image acquisition apparatus, image data representing the entire sample needs to be acquired by connecting a plurality of pieces of image data acquired by moving the sample in a horizontal direction to image the sample a plurality of times or imaging the sample while scanning the sample. Therefore, an objective optical system having a wide field (imaging area) is required to shorten a period of time required to acquire image data by reducing the number of times of imaging. Further, an objective optical system having not only a wide imaging area but also high resolution in a visible light area is required in observing the sample.

A numerical aperture (NA) of the objective optical system needs to be increased to obtain high resolution. When the NA is increased, however, a depth of focus is reduced. If there is an irregularity in a depth direction on a surface of the sample, an image of the sample formed by the objective optical system becomes irregular in shape. Accordingly, particularly in the objective optical system having high resolution and having a wide imaging area, an out-of-focus portion occurs in a part of the sample.

Japanese Patent Application Laid-Open No. 2007-208775 discusses an image pickup apparatus capable of correcting curvature of field of a photographic lens by deforming an image pickup area. In this image pickup apparatus, each of a plurality of photo-electric conversion elements is driven, to deform the image pickup area depending on curvature of field. Japanese Patent Application Laid-Open (Translation of PCT Application) No. 2001-507258 (corresponding to U.S. patent application Ser. No. 08/772977) discusses an apparatus capable of correcting wavefront distortion using a deformable mirror. In this apparatus, the mirror is deformed based on a measured value of wave aberration of the eyes, to correct the aberration.

In the image pickup apparatus discussed in Japanese Patent Application Laid-Open No. 2007-208775, an electric circuit for readout of each of the photoelectric conversion elements and a drive unit for deforming the image pickup area are required. Further, if the photoelectric conversion element is cooled to reduce noise of image data, a cooling mechanism such as an element or an electric circuit for temperature regulation needs to be provided. Particularly if each of the photoelectric conversion elements is provided with the drive unit, therefore, the cooling mechanism is spatially difficult to arrange in addition to the drive unit. The image pickup area needs to be more greatly deformed to adjust a focus for an irregularity of the sample. However, a wider space is required to provide a drive unit for enabling sufficient deformation in such a configuration. Accordingly, a configuration of the image pickup apparatus discussed in Japanese Patent Application Laid-Open No. 2007-208775 is not sufficient to enable focusing throughout a wide imaging area and obtain high image-quality (low-noise) image data.

The apparatus discussed in Japanese Patent Application Laid-Open No. 2001-507258 includes a mechanism for adjusting a wavefront. However, the wavefront is adjusted at a pupil position of an optical system. If such a mechanism is directly applied to the image acquisition apparatus, therefore, an out-of-focus distribution within an imaging area due to an irregularity of a sample cannot be corrected. A larger amount of driving than that during deforming of the mirror for the aberration correction is required to adjust a focus at an image surface position of the sample.

### SUMMARY OF INVENTION

The present invention is directed to a microscope, an objective optical system, and an image acquisition apparatus having high resolution and enabling focusing throughout a wide imaging area.

According to an aspect of the present invention, a microscope includes an objective optical system including an imaging optical system configured to form an image of an object, a re-imaging optical system configured to re-form an image of the object image formed by the imaging optical system, and a reflection unit arranged on an optical path between the imaging optical system and the re-imaging optical system and configured to be locally changeable in at least one of a position thereof in an optical axis direction and an inclination thereof relative to an optical axis, and an image sensor configured to capture the image re-formed by the objective optical system.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic view of principal components of an image acquisition system according to an exemplary embodiment of the present invention.

FIG. 2 illustrates a method for adjusting a focus by a reflection unit according to the exemplary embodiment of the present invention.

FIG. 3 is a schematic view of principal components of an objective optical system according to a first exemplary embodiment.

FIG. 4 is a schematic view of principal components of an objective optical system according to a second exemplary embodiment.

FIG. 5 is a schematic view of principal components of an objective optical system according to a third exemplary embodiment.

FIG. 6 is a schematic view of principal components of an objective optical system according to a fourth exemplary embodiment.

FIG. 7 is a schematic view of principal components of an objective optical system according to a fifth exemplary embodiment.

FIG. 8 is a schematic view of principal components of an objective optical system according to a sixth exemplary embodiment.

FIG. 9 is a schematic view of principal components of an objective optical system according to a seventh exemplary embodiment.

FIG. 10 is a schematic view of principal components of an objective optical system according to an eighth exemplary embodiment.

FIG. 11 illustrates a method for adjusting a focus by tilting the reflection unit according to the exemplary embodiment of the present invention.

FIG. 12 is a schematic view of principal components of a drive unit for deforming the reflection unit according to the exemplary embodiment of the present invention.

FIG. 13 is a schematic view of principal components of a drive unit for driving a plurality of reflection members according to the exemplary embodiment of the present invention.

### DESCRIPTION OF EMBODIMENTS

Various exemplary embodiments, features, and aspects of the invention will be described in detail below with reference to the drawings.

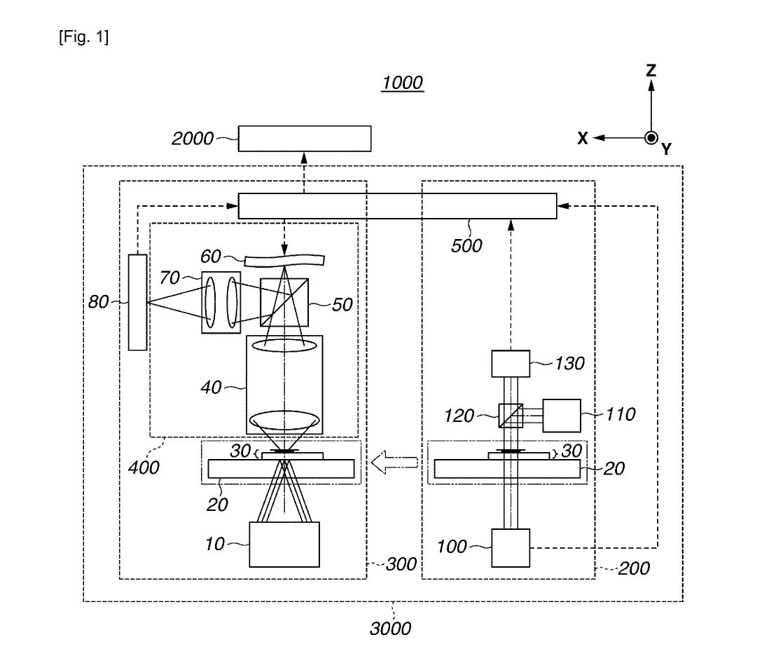

FIG. 1 is a schematic view of principal components of an image acquisition system 1000 according to an exemplary embodiment of the present invention. The image acquisition system 1000 includes an image acquisition apparatus 3000 serving as a microscope that acquires an image of a sample and an image display unit 2000 that displays the acquired image. The image acquisition apparatus 3000 includes a measurement unit 200 that measures a prepared slide 30 including a sample, an imaging unit 300 that captures an image of the prepared slide 30, and an image processing/control unit 500 that controls the measurement unit 200 and the imaging unit 300 and processes a captured image.

An image acquisition procedure in the image acquisition apparatus 3000 according to the present exemplary embodiment will be described below.

The prepared slide 30 including the sample is held on an imaging stage 20, and is arranged in the measurement unit 200. Light fluxes from a measurement light source 110 are deflected by a beam splitter 120, to irradiate the prepared slide 30. The light flux, which has passed through the prepared slide 30, is incident on an X-Y position measurement sensor 100. Data such as a size and positions in X-Y directions of the sample in the prepared slide 30, which have been measured in the X-Y position measurement sensor 100, are sent to the image processing/control unit 500. The X-Y position measurement sensor 100 includes a commercially available charge coupled device (CCD) sensor. On the other hand, the light flux, which has been reflected by the prepared slide 30, is incident on a Z shape measurement sensor 130 after passing through the beam splitter 120. The Z shape measurement sensor 130 measures position data in the Z direction (a Z shape) at each of the X-Y positions of the sample in the prepared slide 30, and sends the measured Z shape to the image processing/control unit 500. The Z shape measurement sensor 130 includes a commercial available Shack-Hartmann sensor. The image processing/control unit 500 stores the sent measurement data (the X-Y positions, the size, and the Z shape of the sample) on the prepared slide 30 in a memory. The measurement unit 200 is not limited to such a configuration. For example, the X-Y positions and the Z shape may be respectively measured using separate light sources at separate positions. When the measurement ends, the imaging stage 20, which holds the prepared slide 30, moves from a measurement position of the measurement unit 200 to an imaging position of the imaging unit 300.

In the imaging unit 300, light from a light source (not illustrated) is incident on an illumination optical system 10. The illumination optical system 10 uniformly illuminates the prepared slide 30. At this time, the light from the light source includes visible light having a wavelength of 400 nm to 700 nm. The light flux from the sample in the prepared slide 30 is incident on an objective optical system 400. The objective optical system 400 according to the present exemplary embodiment includes an imaging optical system 40, a beam splitter 50, a reflection unit (a reflection mirror) 60, and a re-imaging optical system 70. The imaging optical system 40 causes the light flux from the sample to form an image of the sample in the vicinity of the reflection unit 60 via the beam splitter 50. The light flux forming an image of the sample is reflected by the reflection unit 60, and is deflected outward from an optical path of the imaging optical system 40 after passing through the beam splitter 50 again. The deflected light flux is incident on the re-imaging optical system 70 so that the image of the sample is reformed on an image pickup area of an image sensor 80. A local position and inclination of the reflection unit 60 are changeable. The image processing/control unit 500 controls the local position and inclination of the reflection unit 60 according to the measurement data so that an image surface is aligned on the image pickup area of the image sensor 80 (details thereof will be described below).

The imaging optical system 40 may form the image of the sample by image-forming the sample not only once but also a plurality of times. For example, the imaging optical system 40 including a catadioptric system can form an intermediate image in a process for image-forming the sample in the vicinity of the reflection unit 60. More specifically, in the objective optical system 400 according to the present exemplary embodiment, the light flux may be reflected by the reflection unit 60 in the vicinity of a final image-forming position by the imaging optical system 40 and re-focused via the re-imaging optical system 70. The light flux may be focused any number of times. The re-imaging optical system 70 can desirably be an enlargement system that enlarges the image of the sample formed by the imaging optical system 40 at a predetermined lateral magnification and re-forms the enlarged image.

Image data is generated by imaging the sample, which has been re-image-formed on the image pickup area of the image sensor 80 and processing acquired imaging information in the image processing/control unit 500. The image data can be displayed on the image display unit 2000. The image processing/control unit 500 performs processing according to the use, for example, processing for correcting aberration, which cannot be corrected by the objective optical system 400, and processing for connecting a plurality of pieces of image data together to generate single image data.

A method for adjusting a focus by changing an image surface position of the imaging optical system 40 by the reflection unit 60 will be described below.

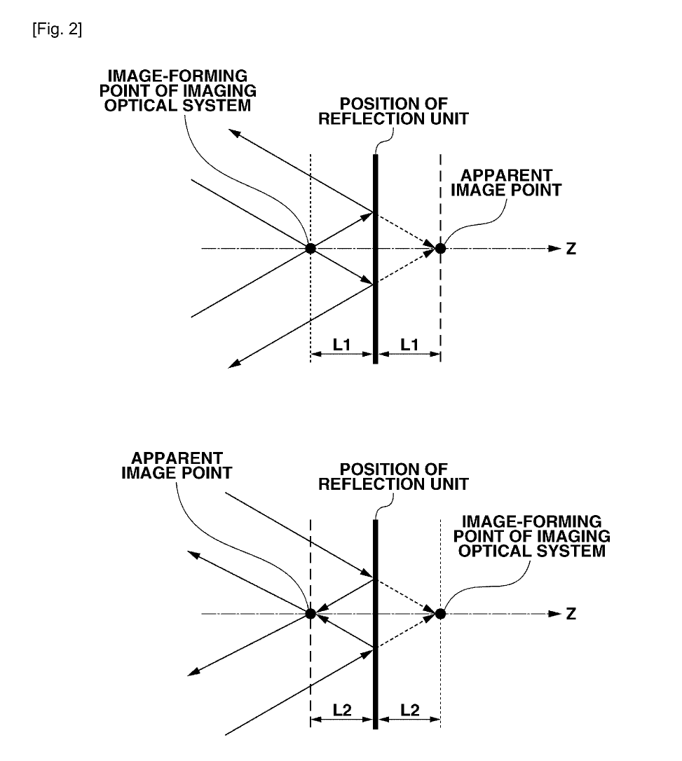

FIG. 2 schematically illustrates a positional relationship between an image-forming point corresponding to a part of the sample, which is formed by the imaging optical system 40, and a reflection surface, which reflects the light flux from the sample, of the reflection unit 60. If the reflection unit 60 is arranged a distance L1 behind (in the +Z direction) a position of the image-forming point of the imaging optical system 40, as illustrated in an upper part of FIG. 2, the light flux reflected from the reflection surface forms an apparent image point the distance L1 behind a position of the reflection unit 60. On the other hand, if the reflection unit 60 is arranged a distance L2 in front of (in the −Z direction) the position of the image-forming point of the imaging optical system 40, as illustrated in a lower part of FIG. 2, the light flux forms an apparent image point the distance L2 in front of the position of the reflection unit 60 after being reflected from the reflection surface. The reflection unit 60 is thus arranged on an optical path so that an image-forming position (an image surface position) of an image formed by the imaging optical system 40 can be changed.

If the shape of the sample is uneven in the Z direction, the position of the image-forming point of the imaging optical system 40 changes depending on X-Y positions of the sample so that only the imaging optical system 40 cannot form a flat image of the sample. More specifically, even if the image sensor 80 is arranged at the image surface position of the imaging optical system 40, an in-focus image cannot be obtained in the entire imaging area. Therefore, an image pickup area position of the image sensor 80 needs to be arranged as an image surface position of the re-imaging optical system 70 so that a position conjugate thereto (an object position of the re-imaging optical system 70) and an apparent image surface position of the imaging optical system 40 are matched with each other. In other words, a re-image-forming position of the image of the sample to be re-formed by the re-imaging optical system 70 needs to be adjusted to match the image pickup area position of the image sensor 80. As illustrated in FIG. 2, the reflection unit 60 is driven so that each area of the reflection surface of the reflection unit 60 is adjusted to match an intermediate position between the position of the image-forming point of the imaging optical system 40 and the object position of the re-imaging optical system 70. More specifically, at least one of a position in an optical axis direction and an inclination to an optical axis of the reflection unit 60 is locally adjusted depending on whether the reflection unit 60 is deformed or whether the reflection unit 60 is constituted by a plurality of reflection members and a position and an inclination of each of the reflection members is changed. Such a method enables matching between the object position of the re-imaging optical system 70 and the apparent image surface position of the imaging optical system 40 and enables a focus to be adjusted so that the image of the sample re-formed by the re-imaging optical system 70 is formed on the image pickup area of the image sensor 80.

As described above, the objective optical system 400 according to the present exemplary embodiment has a configuration in which the reflection unit 60 is arranged on the optical path between the imaging optical system 40 and the re-imaging optical system 70, and the light flux focused by the imaging optical system 40 is reflected by the reflection unit 60 and re-focused via the re-imaging optical system 70. When the re-imaging optical system 70 is an enlargement system having a predetermined lateral magnification, the image of the sample formed by the imaging optical system 40 is enlarged at the lateral magnification and re-formed. When an object point is moved in the optical axis direction relative to the re-imaging optical system 70, an amount of movement of a corresponding image point is increased according to a longitudinal magnification (the square of the lateral magnification). If the image-forming position of the imaging optical system 40 is changed by driving the reflection unit 60, therefore, an amount of displacement of the reflection unit 60 is increased at the longitudinal magnification of the re-imaging optical system 70 so that a re-image-forming position is changed in the larger amount of displacement. More specifically, the enlargement system is used as the re-imaging optical system 70 so that a mechanism for greatly displacing an image surface, as in the conventional technique, is not required. Even if the amount of displacement of the reflection unit 60 is reduced, focusing can be satisfactorily performed.

As described above, the objective optical system 400 according to the present exemplary embodiment enables focusing throughout a wide imaging area by locally changing at least one of the position in the optical axis direction and the inclination to the optical axis of the reflection unit 60 in conformity with the uneven shape of the sample.

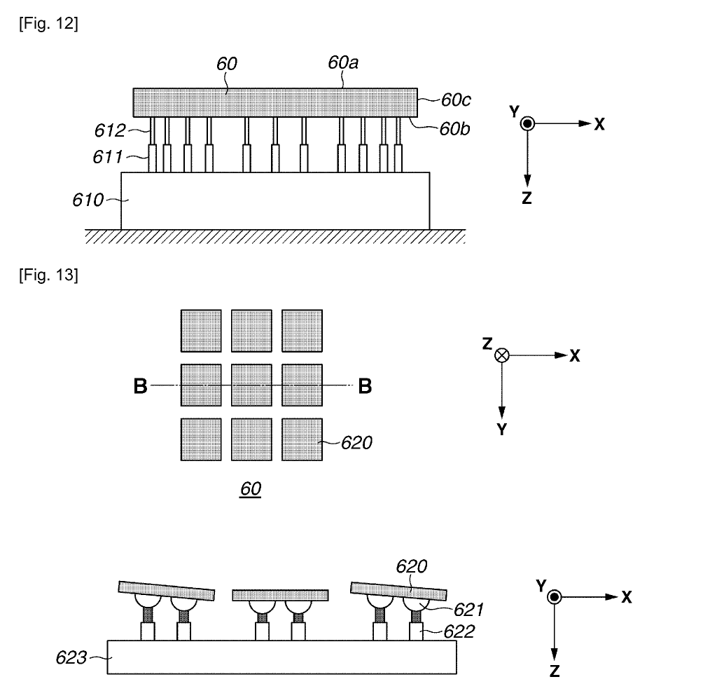

A drive unit for driving the reflection unit 60 will be described below with reference to FIGS. 12 and 13. In the present exemplary embodiment, a method for locally changing at least one of a position in an optical axis direction and an inclination to an optical axis of the reflection unit 60 assumes a deformation of the reflection unit 60 or a change in a position or an inclination of a reflection unit including a plurality of reflection members.

A drive unit for deforming the reflection unit 60 will be described below. FIG. 12 is a cross-sectional view illustrating a configuration of the reflection unit 60 and a drive unit for changing its shape. The reflection unit 60 includes a reflection surface 60a producing a reflection function and a back surface 60b serving as a reverse surface opposite the reflection surface 60a. While the reflection unit 60 has its shape physically changeable, a low thermal expansion material is desirably used to prevent a thermal deformation. A base 610 is a substrate the position of which is fixed within the image acquisition apparatus 3000. The drive unit for deforming the reflection unit 60 includes a plurality of pairs of drive rods 612 and actuators 611. The drive rod 612 has its end fixed to the back surface 60b of the reflection unit 60 or contacting the back surface 60b. The actuator 611 drives the drive rod 612 in the Z direction. The actuator 611 can apply a deformation force to the reflection unit 60 via the drive rod 612. Therefore, the reflection unit 60 can be changed to a desired shape by driving each of the actuators 611. The drive rod 612 desirably uses a high rigidity material having a low thermal expansion characteristic. The actuator 611 includes a linear motor, an electromagnet, and a piezoelectric element. An arrangement of the drive unit is determined, as needed, depending on an arrangement of an image sensor and a target surface shape of the reflection unit 60. By using the drive unit, the shape of the reflection unit 60 is changed so that at least one of a position in an optical axis direction (Z direction) and an inclination to an optical axis of the reflection unit 60 can be locally changed. Accordingly, an image of an object is formed on an image pickup area of the image sensor by changing the shape of the reflection unit 60 in conformity with an uneven shape in the Z direction of a sample, which has been measured by the measurement unit 200, enabling focusing in the entire imaging area.

A drive unit for changing a position and an inclination of a reflection unit including a plurality of reflection members will be described below. FIG. 13 is a schematic view of principal components of a drive unit when the reflection unit 60 includes a plurality of reflection members 620. The plurality of reflection members 620 is arranged, when a plurality of image sensors is arranged, to respectively correspond to the image sensors, and the number of reflection members 620 is determined, as needed, to correspond to the number of image sensors. In the present exemplary embodiment, suppose 3×3 reflection members 620 are arranged in X-Y directions to simplify the description. An upper part of FIG. 13 illustrates the reflection unit 60 as viewed from the −Z direction to the +Z direction, and a lower part of FIG. 13 is a perspective view taken along line B-B of the upper part. Each of the reflection members 620 includes a connection member 621 and a driving member (a cylinder) 622 as the drive unit. The driving member 622 in each of the reflection members 620 is provided on a surface plate 623. Three connection members 621 and three driving members 622 (only two connection members 621 and two driving member 622 on this side are illustrated in the lower part of FIG. 13) are provided in each of the reflection members 620 in the present exemplary embodiment. By providing the drive unit, a position in the optical axis direction (Z direction) of each of the reflection members 620 can be changed under control of the corresponding driving member 622 while an inclination of the reflection member 620 can also be changed. More specifically, at least one of the position in the optical axis direction (Z direction) and the inclination of the reflection unit 60 can be locally changed. Therefore, each of the plurality of reflection members 620 in the reflection unit 60 is driven so that an image of an object is formed on an image pickup area of the corresponding image sensor, enabling focusing in the entire imaging area.

An image-forming position of the sample can be adjusted by locally changing at least one of the position in the optical axis direction and the inclination to the optical axis of the reflection unit 60 in the objective optical system 400, as described above. In the image acquisition apparatus 3000 according to the present exemplary embodiment, the reflection unit 60 and the image sensor 80 are respectively arranged at spatially different positions. Therefore, a mechanism for driving the reflection unit 60 and an electric circuit or a temperature regulation mechanism in the image sensor 80 can be appropriately arranged.

As described above, the objective optical system 400 according to the present exemplary embodiment can obtain in-focus image data, which is high in image quality (low in noise), throughout a wide imaging area.

A configuration of the objective optical system 400 will be described in detail below in each of exemplary embodiments.

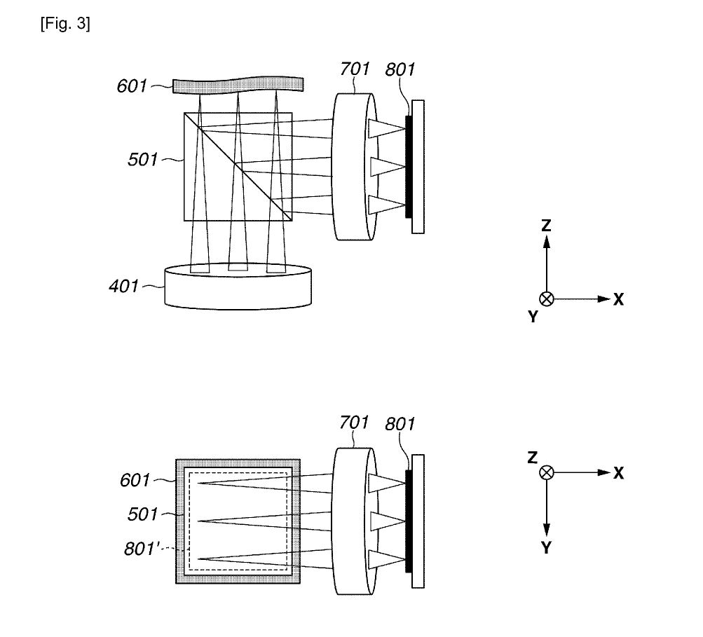

FIG. 3 is a schematic view of principal components of an objective optical system 400 according to a first exemplary embodiment, illustrating the objective optical system 400 as viewed from the −Y direction to the +Y direction and the objective optical system 400 as viewed from the −Z direction to the +Z direction (the imaging optical system 401 is not illustrated).

In FIG. 3, the objective optical system 400 includes an imaging optical system 401, a beam splitter 501, a reflection unit 601, a re-imaging optical system 701, and an image sensor 801. A range 801′ (a broken line) on the reflection unit 601 corresponds to an image pickup area of the image sensor 801.

Light fluxes from a sample in a prepared slide 30 are incident on the imaging optical system 401, to form an image of the sample in the vicinity of the reflection unit 601 via the beam splitter 501. The light fluxes forming the image of the sample are reflected by the reflection unit 601, and are deflected outward from an optical path of the imaging optical system 401 after passing through the beam splitter 501 again. The re-imaging optical system 701 causes the deflected light fluxes to re-form the image of the sample on an image pickup area of the image sensor 801. The reflection unit 601 is deformed in conformity with an uneven shape in the Z direction of the sample so that the image of the sample to be re-formed by the re-imaging optical system 701 is formed on the image pickup area of the image sensor 801. Thus, in-focus image data can be acquired in the entire imaging area.

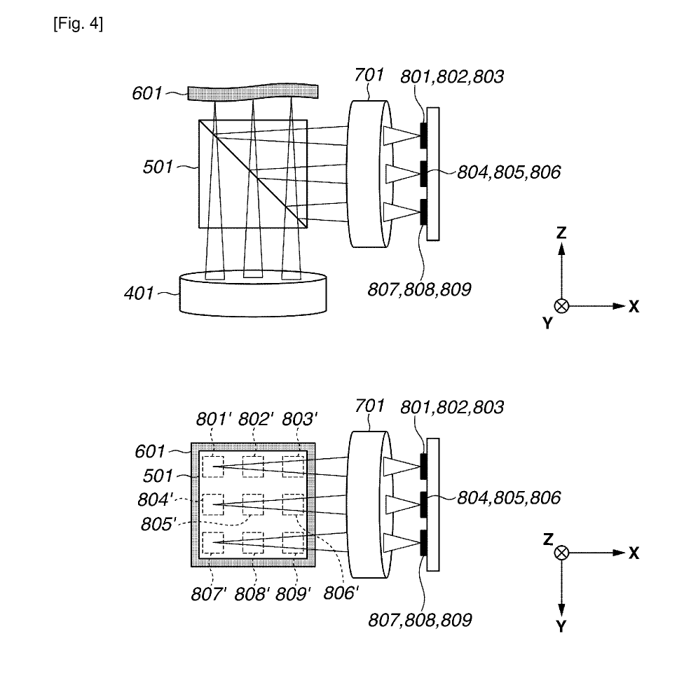

FIG. 4 is a schematic view of principal components of an objective optical system 400 according to a second exemplary embodiment. In FIG. 4, the same members as those illustrated in FIG. 3 are assigned the same reference numerals. In FIG. 4, ranges 801′ to 809′ (broken lines) on a reflection unit 601 respectively correspond to image pickup areas of image sensors 801 to 809. A configuration according to the second exemplary embodiment differs from the configuration according to the first exemplary embodiment in that plurality of image sensors 801 to 809 are arranged.

Light fluxes from a sample in a prepared slide 30 are incident on an imaging optical system 401, to form an image of the sample in the vicinity of a reflection unit 601 via a beam splitter 501. The light fluxes forming the image of the sample are reflected by the reflection unit 601, and are deflected outward from an optical path of the imaging optical system 401 after passing through the beam splitter 501 again. A re-imaging optical system 701 causes the deflected light fluxes to re-form the image of the sample on image pickup areas of the image sensors 801 to 809. The reflection unit 601 is deformed in conformity with an uneven shape in the Z direction of the sample so that the image of the sample to be re-formed by the re-imaging optical system 701 is formed on the image pickup areas of the image sensors 801 to 809. Thus, in-focus image data can be acquired throughout the imaging areas respectively imaged by the image sensors 801 to 809.

In the second exemplary embodiment, the plurality of image sensors 801 to 809 is arranged so that in-focus image data can be obtained throughout a wider imaging area. If areas, which cannot be imaged, occur among the respective image pickup areas of the image sensors 801 to 809, a clearance also occurs in the acquired image data. To fill the areas that cannot be imaged, the sample is imaged while being stepped by moving its position in X-Y directions. At this time, the shape of the reflection unit 601 is changed to a different shape for each step in conformity with the uneven shape in the Z direction of the sample at each of image-forming positions. The image processing/control unit 500 connects image data acquired in the respective steps together so that single image data having no clearance can be generated.

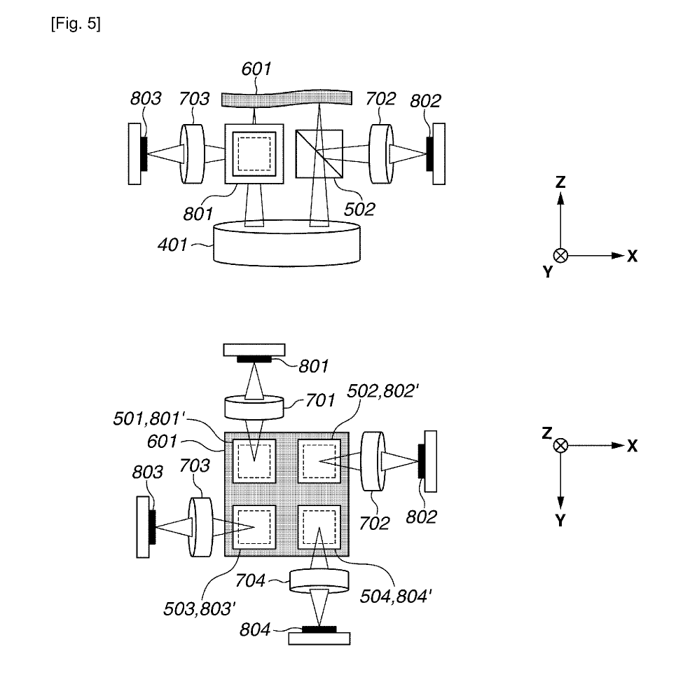

FIG. 5 is a schematic view of principal components of an objective optical system 400 according to a third exemplary embodiment. In FIG. 5, the same members as those illustrated in FIG. 3 or 4 are assigned the same reference numerals. The objective optical system 400 includes beam splitters 501 to 504 (solid lines) and re-imaging optical systems 701 to 704. Ranges 801′ to 804′ (broken lines) on a reflection unit 601 respectively correspond to image pickup areas of image sensors 801 to 804. A configuration according to the third exemplary embodiment differs from the configuration according to the second exemplary embodiment in that the plurality of beam splitters 501 to 504 and the plurality of re-imaging optical systems 701 to 704 are respectively arranged to correspond to the plurality of image sensors 801 to 804, and the image sensors 801 to 804 are respectively arranged within different planes.

Light fluxes from a sample in a prepared slide 30 are incident on an imaging optical system 401, to form an image of the sample in the vicinity of the reflection unit 601 via the beam splitters 501 to 504. The light fluxes forming the image of the sample are reflected by the reflection unit 601, and are deflected outward from an optical path of the imaging optical system 401 after respectively passing through the beam splitters 501 to 504 again. At this time, the plurality of beam splitters 501 to 504 deflects the light fluxes, respectively, in different directions. The re-imaging optical systems 701 to 704 respectively cause the deflected light fluxes to re-form the image of the sample on image pickup areas of the image sensors 801 to 804.

The reflection unit 601 is deformed in conformity with an uneven shape in the Z direction of the sample so that the image of the sample to be re-formed by the reimaging optical systems 701 to 704 is formed on the image pickup areas of the image sensors 801 to 804. Thus, in-focus image data can be acquired throughout the imaging areas respectively imaged by the image sensors 801 to 804. For areas, which cannot be imaged, among the respective image pickup areas of the image sensors 801 to 804, the sample is imaged while being stepped by moving its position in X-Y directions, and a plurality of pieces of the acquired image data are connected together so that single image data having no clearance can be generated, like in the second exemplary embodiment.

In the third exemplary embodiment, the plurality of beam splitters 501 to 504 is arranged so that a wide imaging area can be imaged using a smaller-sized beam splitter. This is advantageous in that a difficulty level of manufacture of the beam splitter is reduced. A distance between the imaging optical system 401 and the reflection unit 601 (a back focus of the imaging optical system 401) can be reduced, and each of the image pickup areas is reduced. Therefore, the re-imaging optical system can also be miniaturized. This is advantageous in that a difficulty level of design of the objective optical system 400 is reduced. In the third exemplary embodiment, the image sensors 801 to 804 are respectively arranged within different planes, and the beam splitters 501 to 504 and the re-imaging optical systems 701 to 704 re-form the image of the sample on the image pickup areas of the image sensors 801 to 804. Such a configuration allows spatial room between the image sensors 801 to 804, and enables an arrangement of an electric circuit, a temperature regulation mechanism, or the like more appropriately for each of the image sensors 801 to 804.

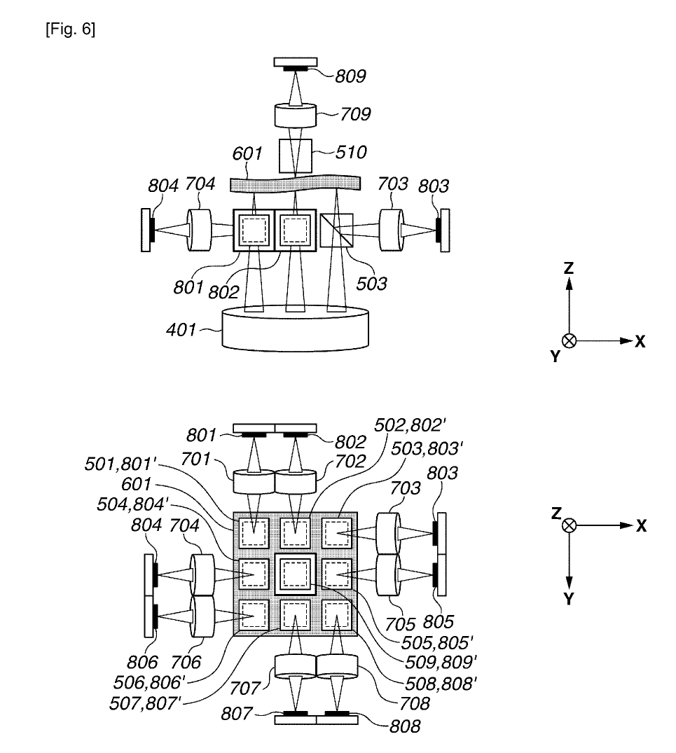

FIG. 6 is a schematic view of principal components of an objective optical system 400 according to a fourth exemplary embodiment. In FIG. 6, the same members as those in any of FIGS. 3 to 5 are assigned the same reference numerals. The objective optical system 400 includes beam splitters 501 to 508 (solid lines), parallel flat glasses 509 and 510, and re-imaging optical systems 701 to 709. Ranges 801′ to 809′ (broken lines) on a reflection unit 601 respectively correspond to image pickup areas of image sensors 801 to 809. A configuration according to the fourth exemplary embodiment differs from the configuration according to the third exemplary embodiment in that respective numbers of beam splitters, re-imaging optical systems, and image sensors are increased, an opening is provided in the range 809′ on the reflection unit 601 corresponding to the image pickup area of the image sensor 809, and the parallel flat glasses 509 and 510 are provided.

Light fluxes from a sample in a prepared slide 30 are incident on an imaging optical system 401. The light fluxes corresponding to the image pickup areas of the image sensors 801 to 808 out of the light fluxes form an image of the sample in the vicinity of the reflection unit 601 via the beam splitters 501 to 508. The light fluxes forming the image of the sample are reflected by the reflection unit 601, and are deflected outward from an optical path of the imaging optical system 401 after respectively passing through the beam splitters 501 to 508 again. The re-imaging optical systems 701 to 708 respectively cause the deflected light fluxes to re-form the image of the sample on image pickup areas of the image sensors 801 to 808.

The light flux corresponding to the image pickup area of the image sensor 809 out of the light fluxes from the sample forms an image of the sample in the vicinity of the opening provided in the range 809′ on the reflection unit 601 after passing through the parallel flat glass 509. The re-imaging optical system 709 causes the light flux, which has passed through the opening, to re-form the image of the sample on an image pickup area of the image sensor 809 after passing through the parallel flat glass 510. The parallel flat glasses 509 and 510 are arranged to match respective optical path lengths of the light flux that passes through the opening and the light fluxes that respectively pass through the beam splitters 501 to 508.

The light fluxes can be respectively incident more appropriately on the image pickup areas by thus passing only the light flux at the center of the reflection unit 601 corresponding to the image pickup area of the image sensor 809 through the opening. To reform an image of the sample on the image pickup area of the image sensor 809 without providing the parallel flat glass, an optical system, which differs from the re-imaging optical systems 701 to 708, may be used as the re-imaging optical system 709.

In a focusing procedure in the fourth exemplary embodiment, a position (Z position) in an optical axis direction and an inclination to an optical axis (an X-Y tilted position) of the sample are aligned so that the light flux corresponding to the image pickup area of the image sensor 809 is focused on the image pickup area of the image sensor 809. The most suitable X-Y tilted position is found by a least-square method or the like from a shape corresponding to the image pickup area of the image sensor 809 of the sample acquired by measurement, and can be adjusted by a stage (not illustrated) for storing the sample. This position is used as a basis, to deform the reflection unit 601. More specifically, the reflection unit 601 is deformed so that the image of the sample to be re-formed by the re-imaging optical systems 701 to 708 is formed on the image pickup areas of the image sensors 801 to 808 in conformity with an uneven shape in the Z direction of the sample. Thus, in-focus image data can be acquired respectively by the image sensors 801 to 809.

For areas, which cannot be imaged, among the respective image pickup areas of the image sensors 801 to 809, the sample is imaged while being stepped by moving its position in X-Y directions. At that time, the position and the inclination of the sample and the shape of the reflection unit 601 are changed for each step in conformity with the uneven shape in the Z direction of the sample at each of imaging positions. The image processing/control unit 500 connects image data acquired in the respective steps together so that single image data having no clearance can be generated.

In the fourth exemplary embodiment, the plurality of beam splitters 501 to 508 is arranged so that a wide imaging area can be imaged using a smaller-sized beam splitter than that in the third exemplary embodiment. Thus, a difficulty level of manufacture of the beam splitter can be made lower. A back focus of the imaging optical system 401 can also be made smaller, and each of the image pickup areas becomes smaller. Therefore, the re-imaging optical system can be made smaller in size. This is advantageous in that a difficulty level of design of the objective optical system 400 is reduced.

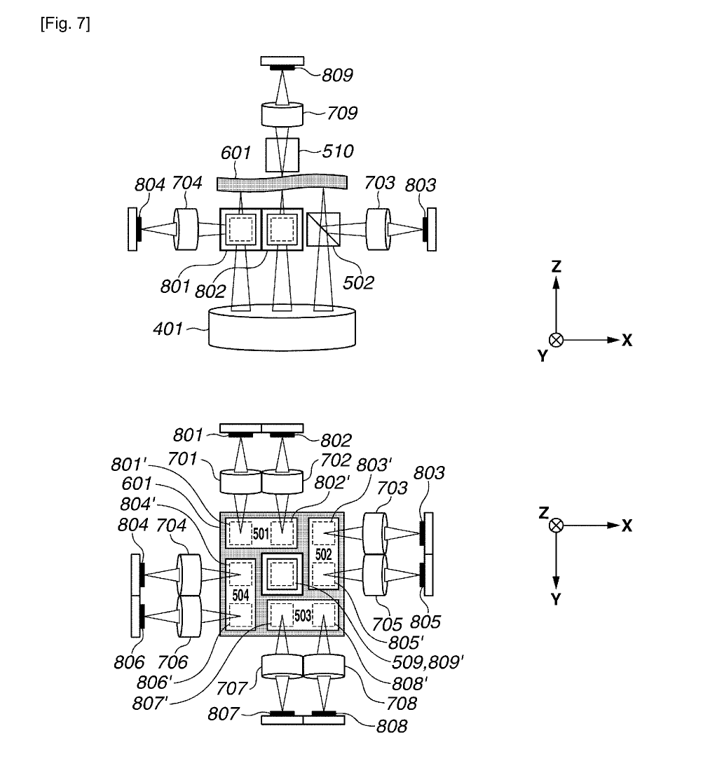

FIG. 7 is a schematic view of principal components of an objective optical system 400 according to a fifth exemplary embodiment. In FIG. 7, the same members as those illustrated in FIG. 6 are assigned the same reference numerals. The objective optical system 400 includes beam splitters 501 to 504 (solid lines). A configuration according to the fifth exemplary embodiment differs from the configuration according to the fourth exemplary embodiment in that the adjacent beam splitters 501 to 508 are respectively collected as the beam splitters 501 to 504 in a rectangular parallelepiped shape.

An optical path of light fluxes from a sample and a method and a procedure for focusing and image data generation in the fifth exemplary embodiment are substantially the same as those in the fourth exemplary embodiment. However, in the fifth exemplary embodiment, a plurality of beam splitters corresponding to a plurality of image pickup areas are collected as the beam splitters 501 to 504 in a rectangular parallelepiped shape. Thus, a mechanism for storing the beam splitters and position adjustment can be made simpler. This is advantageous in that a difficulty level of assembling and manufacture of the objective optical system 400 is reduced.

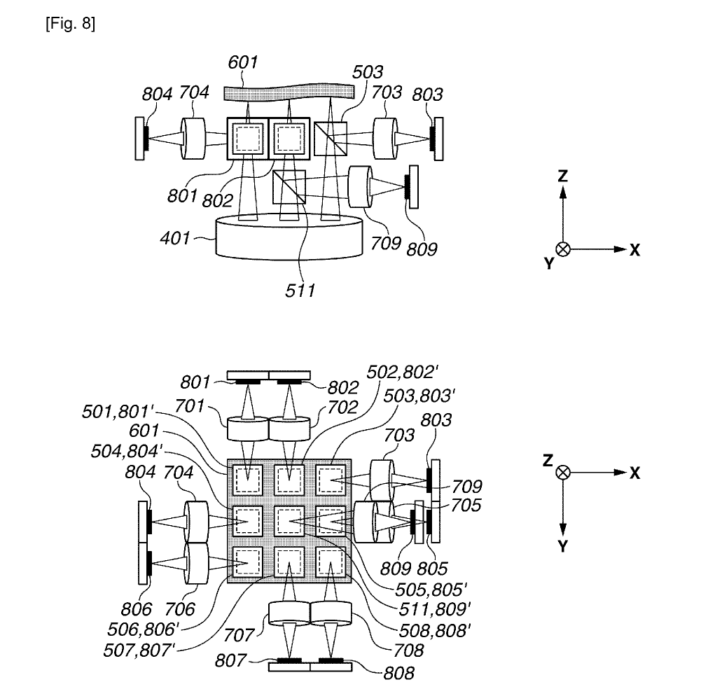

FIG. 8 is a schematic view of principal components of an objective optical system 400 according to a sixth exemplary embodiment. In FIG. 8, the same members as those illustrated in FIG. 6 are assigned the same reference numerals. A configuration according to the sixth exemplary embodiment differs from the configuration according to the fourth exemplary embodiment in that the opening in the reflection unit 601 and the parallel flat glasses 509 to 510 are not provided and a beam splitter 511 (a solid line) is newly provided. The beam splitter 511 is arranged at a position different in an optical axis direction (Z direction) of an imaging optical system 401 from beam splitters 501 to 508 to appropriately deflect an optical path of a light flux to an image pickup area of an image sensor 809.

Light fluxes from a sample in a prepared slide 30 are incident on the imaging optical system 401, and the light fluxes corresponding to image pickup areas of image sensors 801 to 808 and 809 form an image of the sample in the vicinity of a reflection unit 601 via the beam splitters 501 to 508 and 511. The light fluxes forming the image of the sample are reflected by the reflection unit 601, and are deflected outward from an optical path of the imaging optical system 401 after respectively passing through the beam splitters 501 to 508 and 511 again. The re-imaging optical systems 701 to 709 respectively cause the deflected light fluxes to re-form the image of the sample on image pickup areas of the image sensors 801 to 809. Thus, the beam splitter 511 arranged at the different position in the Z direction deflects only the light flux at the center of the reflection unit 601 corresponding to the image pickup area of the image sensor 809 so that the light flux can be appropriately incident on each of the image pickup areas.

The reflection unit 601 is deformed in conformity with an uneven shape in the Z direction of the sample so that the image of the sample to be re-formed by the reimaging optical systems 701 to 709 is formed on the image pickup areas of the image sensors 801 to 809. Thus, in-focus image data can be acquired throughout the imaging areas respectively imaged by the image sensors 801 to 809. For areas, which cannot be imaged, among the respective image pickup areas of the image sensors 801 to 809, the sample is imaged while being stepped by moving its position in X-Y directions, and a plurality of pieces of the acquired image data are connected together so that single image data having no clearance can be generated, like in the second exemplary embodiment.

In the sixth exemplary embodiment, the beam splitter 511 arranged at the different position in the Z direction from the beam splitters 501 to 508 deflects an optical path of the light flux corresponding to the image pickup area of the image sensor 809. This is advantageous in that finer focusing can be performed by not only adjusting the Z position of the sample and an X-Y tilted position but also deforming the reflection unit 601 even with respect to the image pickup area of the image sensor 809.

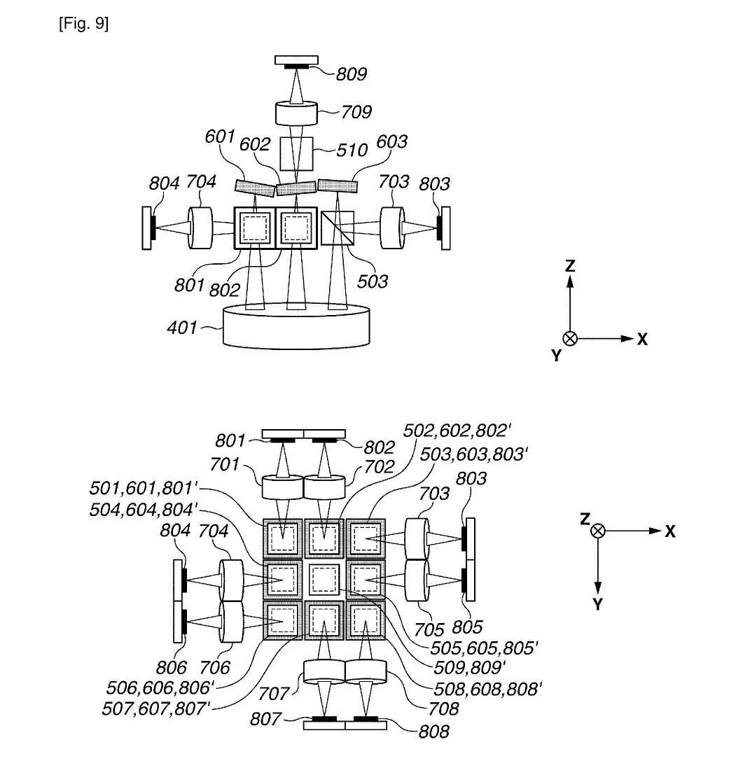

FIG. 9 is a schematic view of principal components of an objective optical system 400 according to a seventh exemplary embodiment. In FIG. 9, the same members as those illustrated in FIG. 9 are assigned the same reference numerals. A configuration according to the seventh exemplary embodiment differs from the configuration according to the fourth exemplary embodiment in that a reflection unit includes a plurality of reflection members 601 to 608.

Light fluxes from a sample in a prepared slide 30 are incident on an imaging optical system 401. The light fluxes corresponding to image pickup areas of image sensors 801 to 808 out of the light fluxes form an image of the sample in the vicinity of the reflection members 601 to 608 via beam splitters 501 to 508. The light fluxes forming the image of the sample are reflected by the reflection members 601 to 608, and are deflected outward from an optical path of the imaging optical system 401 after passing through the beam splitters 501 to 508 again. Re-imaging optical systems 701 to 708 cause the deflected light fluxes to re-form the image of the sample on image pickup areas of the image sensors 801 to 808. The light flux corresponding to an image pickup area of an image sensor 809 out of the light fluxes from the sample are re-focused on an image pickup area of the image sensor 809 after passing through a similar optical path to that in the fourth exemplary embodiment.

In a focusing procedure in the seventh exemplary embodiment, a position (Z position) in an optical axis direction and an inclination to an optical axis (an X-Y tilted position) of the sample are matched, like in the fourth exemplary embodiment, so that the light flux corresponding to the image pickup area of the image sensor 809 is focused on the image pickup area of the image sensor 809. This position is used as a basis, to change respective Z positions and X-Y tilted positions of the reflection members 601 to 608. More specifically, the Z positions and the X-Y tilted positions are changed so that an image of the sample to be re-formed by the re-imaging optical systems 701 to 708 is formed on the image pickup areas of the image sensors 801 to 808 in conformity with an uneven shape in the Z direction of the sample. Thus, in-focus image data can be acquired throughout the imaging areas respectively imaged by the image sensors 801 to 809. For areas, which cannot be imaged, among the respective image pickup areas of the image sensors 801 to 809, the sample is imaged while being stepped by moving its position in X-Y directions, and a plurality of pieces of the acquired image data are connected together so that single image data having no clearance can be generated, like in the second exemplary embodiment.

In the seventh exemplary embodiment, the plurality of reflection members 601 to 608 is arranged as a reflection unit, to enable focusing throughout a wide imaging area without deforming the reflection unit. This is advantageous in that a mechanism for controlling a shape of the reflection unit is not required, to facilitate a spatial arrangement.

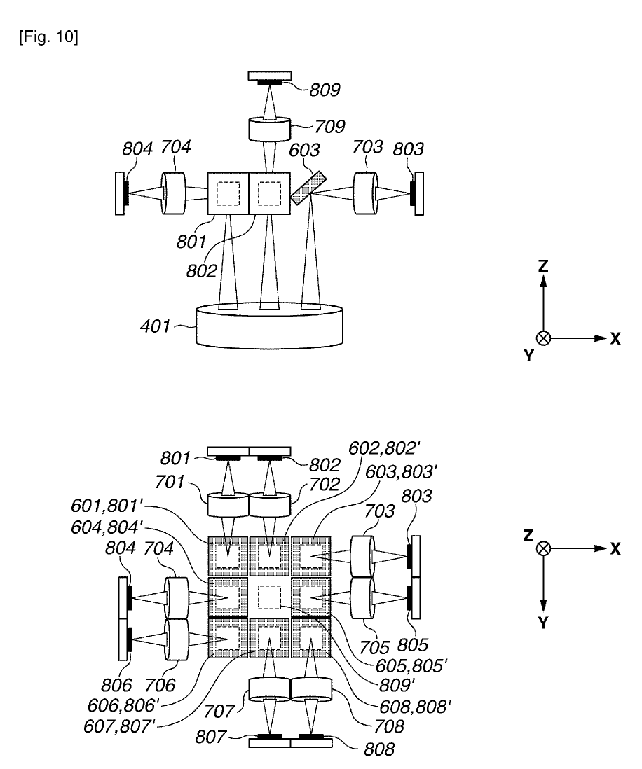

FIG. 10 is a schematic view of principal components of an objective optical system 400 according to an eighth exemplary embodiment. In FIG. 10, the same members as those illustrated in FIG. 9 are assigned the same reference numerals. A configuration according to the eighth exemplary embodiment differs from the configuration according to the seventh exemplary embodiment in that the beam splitters are not arranged, each of a plurality of reflection members 601 to 608 serving as a reflection unit is a 45-degree mirror, and the reflection members 601 to 608 respectively deflect light fluxes outward from an optical path of an imaging optical system 401. At this time, the reflection members 601 to 608 are arranged to respectively deflect the light fluxes in different directions.

Light fluxes from a sample in a prepared slide 30 are incident on the imaging optical system 401. The light fluxes corresponding to image pickup areas of image sensors 801 to 808 out of the light fluxes form an image of the sample in the vicinity of the reflection members 601 to 608. The light fluxes forming the image of the sample are respectively reflected by the reflection members 601 to 608, and are deflected outward from an optical path of the imaging optical system 401. Re-imaging optical systems 701 to 708 respectively cause the deflected light fluxes to re-form the image of the sample on image pickup areas of the image sensors 801 to 808.

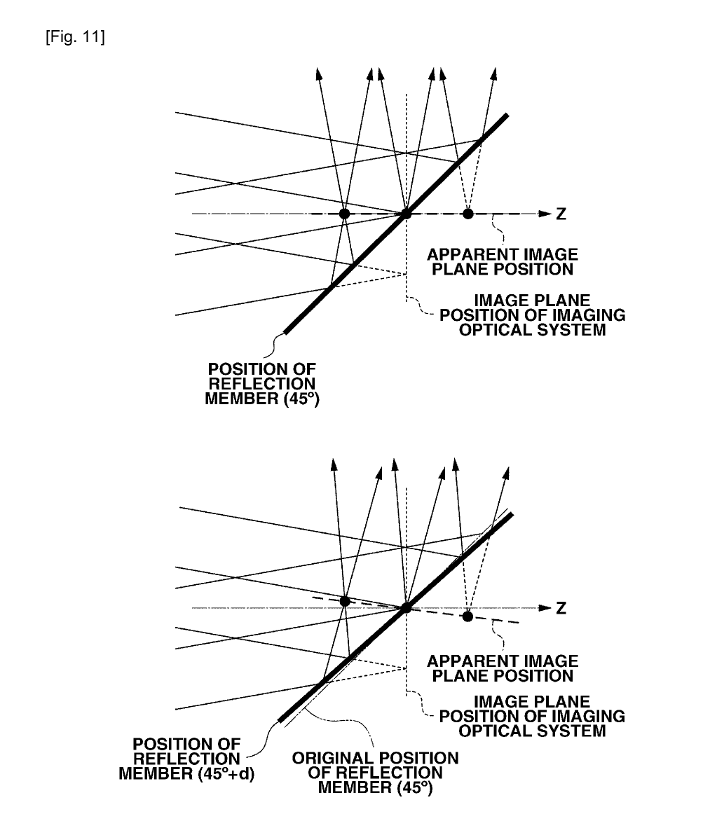

A method for adjusting a focus by tilting each of the reflection members 601 to 608 in the reflection unit will be described below. FIG. 11 schematically illustrates a positional relationship between an image-forming point in the imaging optical system 401 and a reflection surface in one reflection member. If the reflection member is inclined at an angle of 45 degrees to an optical axis (Z-axis) of the imaging optical system 401, as illustrated in an upper part of FIG. 11, the reflection member rotates an image surface of the imaging optical system 401 by 90 degrees. On the other hand, when the reflection member is tilted by only an angle of +d from 45 degrees, as illustrated in a lower part of FIG. 11, an apparent image surface position is also correspondingly tilted. Accordingly, each of the reflection members 601 to 608 is tilted using this relationship so that object positions of the re-imaging optical systems 701 to 708 and a tilt component of an apparent image surface position of the imaging optical system 401 can be matched with each other. Thus, tilt components of image surface positions of the re-imaging optical systems 701 to 708 can be aligned on the image pickup areas of the image sensors 801 to 808. At this time, a traveling direction of the light flux also changes by tilting the reflection member. However, the numerical apertures (NAs) of the re-imaging optical systems 701 to 708 are desirably sufficiently ensured so that the traveling direction falls within the optical paths of the re-imaging optical systems 701 to 708.

The light flux corresponding to an image pickup area of an image sensor 809 out of the light fluxes from the sample forms an image in the vicinity of a range 809′ surrounded by the reflection members 601 to 608. Further, the re-imaging optical system 709 re-forms the image of the sample on the image pickup area of the image sensor 809.

A focusing procedure in the eighth exemplary embodiment is similar to that in the seventh exemplary embodiment in that focusing is first performed for the image sensor 809, and the position is used as a basis, to adjust respective Z positions and X-Y tilted positions of the other reflection members 601 to 608. Thus, in-focus image data can be acquired respectively by the image sensors 801 to 809. For areas, which cannot be imaged, among the respective image pickup areas of the image sensors 801 to 809, the sample is imaged while being stepped by moving its position in X-Y directions, and a plurality of pieces of the acquired image data are connected together so that single image data having no clearance can be generated, like in the second exemplary embodiment.

In the eighth exemplary embodiment, focusing is performed throughout a wide imaging area without arranging beam splitters. This is advantageous in that an amount of light is easily ensured.

While focusing is performed in the entire imaging area by driving the reflection unit in any of the above-mentioned exemplary embodiments, driving of the image sensor may be further combined with the driving of the reflection unit. More specifically, an out-of-focus distribution within the imaging area may be arranged by driving the reflection unit, and uniform out-of-focus within the imaging area may be resolved by driving the image sensor in the optical axis direction.

While a single re-imaging optical system corresponds to a single beam splitter in the second exemplary embodiment, a plurality of re-imaging optical systems may be provided, for example, as long as light fluxes from the beam splitter are respectively re-focused on image sensors. While focusing is performed by deforming one reflection unit for a plurality of image sensors in the second exemplary embodiment, a plurality of reflection members may be provided, and a position in an optical axis direction and an inclination of each of the reflection members may be changed, like in the seventh exemplary embodiment.

While one beam splitter in a rectangular parallelepiped shape corresponds to two image pickup areas in the fifth exemplary embodiment, the present invention is not limited to this configuration if light fluxes from a sample can be respectively focused on image pickup areas of image sensors via re-imaging optical systems. More specifically, members may be appropriately arranged, and one beam splitter in a rectangular parallelepiped shape may correspond to three or more image pickup areas. A beam splitter in a rectangular parallelepiped shape, like in the fifth exemplary embodiment, may be applied to the third, sixth, or seventh exemplary embodiments. More specifically, in the present exemplary embodiment, each of light fluxes respectively deflected by a plurality of beam splitters is incident on at least one (one or more) of a plurality of re-imaging optical systems.

In the seventh exemplary embodiment, a reflection member may also be arranged in the range 809′ corresponding to the image sensor 809, and the beam splitters may be arranged at different positions in an optical axis direction (Z direction) of an imaging optical system, like in the sixth exemplary embodiment. Further, in the seventh and eighth exemplary embodiments, finer focusing may be performed by changing respective shapes of reflection members in addition to positions and inclinations thereof.

While the number of image sensors to be arranged is one to nine in any of the exemplary embodiments, one to nine or more image sensors may be arranged. In the case, focusing can be performed, like in the above-mentioned exemplary embodiments, by increasing the respective numbers of beam splitters and re-imaging optical systems and the number of reflection members in a reflection unit to match the number of image sensors. At this time, light fluxes can be appropriately deflected to be respectively incident on image pickup areas by arranging beam splitters at different positions in the Z direction, like in the sixth exemplary embodiment. Light fluxes can be appropriately deflected by respectively arranging the reflection members instead of beam splitters at different positions in the Z direction.

If an odd number of image sensors are arranged, an opening may be provided at the center of a reflection unit, like in the fourth or fifth exemplary embodiment. Thus, a light flux can be appropriately incident on each of image pickup areas. In this configuration, one image sensor, which receives a light flux without via a reflection unit and a beam splitter after passing through the opening, is provided. More specifically, the shape or the position/posture of the reflection unit are changed using an in-focus position on an image pickup area of the one image sensor as a basis so that focusing can be appropriately performed in the other image pickup area. If an odd number of reflection members are arranged in a reflection unit, like in the seventh and eighth exemplary embodiments, the reflection member is not arranged at the center of the reflection unit, and one image sensor, which receives a light flux without via the reflection member after passing through the opening, can be provided. More specifically, the position and the inclination of each of the reflection members are changed using an in-focus position on an image pickup area of the one image sensor as a basis so that focusing can be appropriately performed in a corresponding image pickup area.

As described above, in the fourth and fifth exemplary embodiments and the seventh and eighth exemplary embodiments, the light flux passes through the opening provided in the reflection unit, and is further incident on the re-imaging optical system via the parallel flat glass, to re-form the image of the sample on the image pickup area of the image sensor. On the other hand, the image sensor, which receives the light flux that passes through the opening, may be arranged in an opening portion of the reflection unit. Such an arrangement enables an image of a sample to be formed on the image sensor without providing the parallel flat glass and the re-imaging optical system, as described above. The above-mentioned configuration in which the beam splitters and the reflection members are respectively arranged at different positions in the Z direction and the above-mentioned configuration in which the reflection unit is provided with the opening may be combined with each other.

While a large screen is imaged while being stepped in the second to eighth exemplary embodiments, the present invention is also applicable to an image acquisition apparatus for scanning the large screen. The image acquisition apparatus according to the present invention is not limited to a microscope including an objective optical system that is an enlargement system as a whole to enlarge and observe a sample. For example, the image acquisition apparatus is also useful as an inspection apparatus that performs appearance inspection (adhesion of a foreign material, inspection of a flaw, etc.) of a substrate or the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-180362 filed Aug. 22, 2011, which is hereby incorporated by reference herein in its entirety.

1. A microscope comprising:
an objective optical system including an imaging optical system configured to form an image of an object, a re-imaging optical system configured to re-form an image of the object image formed by the imaging optical system, and a reflection unit arranged on an optical path between the imaging optical system and the re-imaging optical system and configured to be locally changeable in at least one of a position thereof in an optical axis direction and an inclination thereof relative to an optical axis; and
an image sensor configured to capture the image re-formed by the objective optical system.

2. The microscope according to claim 1, further comprising a drive unit configured to locally change at least one of the position of the reflection unit in the optical axis direction and the inclination of the reflection unit relative to the optical axis according to a shape of the object.

3. The microscope according to claim 1, wherein the image sensor includes a plurality of image sensors.

4. The microscope according to claim 1, wherein the reflection unit includes a plurality of reflection members, and at least one of a position in the optical axis direction and an inclination relative to the optical axis of each of the plurality of reflection members is changeable.

5. The microscope according to claim 4, wherein the re-imaging optical system includes a plurality of re-imaging optical systems,
wherein the image sensor includes a plurality of image sensors, and
wherein the plurality of re-imaging optical systems causes light fluxes reflected by the plurality of reflection members to be respectively focused on image pickup areas of the plurality of image sensors.

6. The microscope according to claim 3, wherein at least one of the plurality of image sensors is arranged within a plane different from a plane in which the other image sensor is arranged.

7. The microscope according to claim 4, wherein the reflection unit is provided with an opening, and
wherein the plurality of reflection members is arranged on other than an optical path of a light flux that passes through the opening.

8. The microscope according to claim 3, further comprising a plurality of beam splitters arranged between the imaging optical system and the reflection unit and configured to deflect light fluxes reflected by the reflection unit outward from an optical path of the imaging optical system,
wherein the re-imaging optical system includes a plurality of reimaging optical systems, and
wherein the plurality of re-imaging optical systems is arranged to respectively focus the light fluxes deflected by the plurality of beam splitters on image pickup areas of the plurality of image sensors.

9. The microscope according to claim 8, wherein at least one of the plurality of beam splitters deflects a light flux in a direction different from a direction in which the other beam splitter deflects a light flux.

10. The microscope according to claim 8, wherein at least one of the plurality of beam splitters is arranged at a position different from a position at which the other beam splitter is arranged in the optical axis direction of the imaging optical system.

11. The microscope according to claim 8, wherein the reflection unit is provided with an opening, and
wherein the plurality of beam splitters is arranged on other than an optical path of a light flux that passes through the opening.

12. The microscope according to claim 1, wherein at least one of the position of the reflection unit in the optical axis direction and the inclination of the reflection unit relative to the optical axis is locally changeable by changing a shape of the reflection unit.

13. The microscope according to claim 1, wherein the re-imaging optical system is an enlargement system.

14. The microscope according to claim 1, wherein the objective optical system is an enlargement system.

15. An objective optical system comprising:
an imaging optical system configured to form an image of an object;
a plurality of re-imaging optical systems configured to re-form an image of the object image formed by the imaging optical system; and
a plurality of reflection members arranged on respective optical paths between the imaging optical system and the plurality of re-imaging optical systems and each configured to be changeable at least one of a position thereof in an optical axis direction and an inclination thereof relative to an optical axis.

16. The objective optical system according to claim 15, wherein at least one of the plurality of reflection members is arranged to reflect a light flux from the imaging optical system in a direction different from a direction in which the other reflection member reflects a light flux.

17. The objective optical system according to claim 15, further comprising a plurality of beam splitters respectively arranged between the imaging optical system and the plurality of reflection members and configured to deflect light fluxes reflected by the plurality of reflection members outward from an optical path of the imaging optical system,
wherein the plurality of re-imaging optical systems is arranged to respectively cause the light fluxes deflected by the plurality of beam splitters to re-form an image of the object image.

18. The objective optical system according to claim 17, wherein at least one of the plurality of beam splitters deflects a light flux in a direction different from a direction in which the other beam splitter deflects a light flux.

19. The objective optical system according to claim 17, wherein at least one of the plurality of beam splitters is arranged at a position different from a position at which the other beam splitter is arranged in the optical axis direction of the imaging optical system.

20. The objective optical system according to claim 15, wherein each of the plurality of re-imaging optical systems is an enlargement system.

21. The objective optical system according to claim 15, wherein the imaging optical system and the plurality of re-imaging optical systems constitute an enlargement system.

22. The objective optical system according to claim 15, wherein a shape of each of the plurality of reflection members is changeable.

23. An image acquisition apparatus comprising:
an objective optical system including an imaging optical system configured to form an image of an object, a re-imaging optical system configured to re-form an image of the object image formed by the imaging optical system, and a reflection unit arranged on an optical path between the imaging optical system and the re-imaging optical system and configured to be locally changeable in at least one of a position thereof in an optical axis direction and an inclination thereof relative to an optical axis; and
an image sensor configured to capture the image re-formed by the objective optical system.
